(19) United States
(12) Patent Application Publication
(10) Pub. No.: US 2014/0123260 A1
(43) Pub. Date: May 1, 2014

(54) TERMINAL EQUIPMENT, SERVER, METHOD OF CONTROLLING TERMINAL EQUIPMENT, AND METHOD OF CONTROLLING SERVER

(71) Applicant: Samsung Electronics Co., Ltd., Suwon-si (KR)

(72) Inventors: Kil-soo CHOI, Yongin-si (KR); Jung-rae KIM, Suwon-si (KR); Sang-shin PARK, Daejeon (KR); Jong-min BAEK, Seoul (KR)

(73) Assignee: Samsung Electronics Co., Ltd., Suwon-si (KR)

(21) Appl. No.: 14/063,439

(22) Filed: Oct. 25, 2013

(30) Foreign Application Priority Data
Oct. 25, 2012 (KR) 10-2012-0119200

(51) Int. Cl. H04L 29/06

(52) U.S. Cl. CPC H04L 63/0861
USPC 726/7

(57) ABSTRACT

A terminal, a server, a method of controlling the terminal, and a method of controlling the server are provided. The terminal includes a communication unit which communicates with a server storing a file uploaded by a second terminal, a photographing unit which captures an image of a user of the terminal, and a controller which controls the communication unit to receive client information for client authentication from the server, authenticate a client on the basis of a facial image included in the client information and the image of the user captured by the photographing unit, and receive the uploaded file according to the authentication result when the terminal accesses the server with the same account as the second terminal.

### CROSS-REFERENCE TO RELATED APPLICATIONS

This application claims priority from Korean Patent Application No. 10-2012-0119200, filed on Oct. 25, 2012, in the Korean Intellectual Property Office, the disclosure of which is incorporated herein by reference in its entirety.

### BACKGROUND

1. Field

Apparatuses and methods consistent with exemplary embodiments relate to a terminal, a server, a method of controlling the terminal, and a method of controlling the server, and more particularly, to a terminal, a server, a method of controlling the terminal, and a method of controlling the server, which authenticates another user accessing the server with a client account and provides an uploaded file to the other user.

2. Description of the Related Art

A cloud service denotes a service in which a user stores various file data, such as movies, photographs, music, etc., in a cloud server, and accesses a corresponding server with a terminal, such as an Internet-enabled smart phone or smart television (TV), to download and use a desired file anywhere at any time.

Through the cloud service, a user uploads a file to a cloud server with a terminal of the user, and moreover can access a corresponding server with another user's account to use a file uploaded by the other user. That is, when a plurality of users access a server with the same account using different terminals, the users may use a file uploaded by a user registered with the same account.

As described above, the cloud service enables users to freely share uploaded files. However, in a related art cloud service, since there is no separate restriction in file sharing between users, privacy invasion may occur when a file, for which sharing is not desired among files uploaded by a user, is exposed to other users.

### SUMMARY

Exemplary embodiments address the above disadvantages and other disadvantages not described above. Exemplary embodiments provide a method that enables a user's file uploaded to a server to be shared with another user through a cloud service, within a range in which the user's privacy is not invaded.

A terminal according to an exemplary embodiment includes a communication unit which communicates with a server storing a file uploaded by a second terminal, a photographing unit which captures an image of a user of the terminal, and a controller which controls the communication unit to receive client information for client authentication from the server when the terminal accesses the server with a same account as the second terminal, authenticates the user of the terminal on the basis of a facial image included in the client information and the image of the user captured by the photographing unit, and receives the uploaded file according to the authentication result.

The controller may receive access to the uploaded file when the facial image included in the client information matches the image of the user captured by the photographing unit, and when the facial image included in the client information does not match the image of the user captured by the photographing unit, the controller may control the communication unit to receive access to a file set that is shared by the second terminal.

When the image captured by the photographing unit includes a plurality of user facial images, the controller may control the communication unit to receive a file set that is shared by the second terminal.

When second client information, which further includes event information indicating that a new file has been uploaded, is received from the server, the controller may control the photographing unit to automatically re-capture the image of the user and re-authenticate the user on the basis of a facial image included in the second client information and the image re-captured by the photographing unit.

A server according to an exemplary embodiment includes a communication unit which communicates with a first terminal and a second terminal, a storage unit which stores a file uploaded by a first user of the first terminal, and a controller which controls the communication unit to transmit client information for client authentication to the second terminal when the second terminal accesses the server with a pre-registered account of the first terminal, and when an authentication result is received, to transmit the uploaded file to the second terminal according to the received authentication result.

The client information may include a facial image of the first user, and the authentication result is a result indicating whether the facial image of the first user matches an image of a user captured by the second terminal.

When the received authentication result shows that the facial image of the first user matches the image of the user captured by the second terminal, the controller may transmit the uploaded file to the second terminal, and when the received authentication result shows that the facial image of the first user does not match the image of the user captured by the second terminal, the controller may transmit a file set that is shared by the first terminal to the second terminal.

When a new file is uploaded by the first terminal and stored in the storage unit, the controller may control the communication unit to transmit second client information, which includes event information indicating that the new file has been uploaded, to the second terminal.

A method of controlling a terminal, which communicates with a server to operate according to an exemplary embodiment includes accessing the server with an account of a second terminal pre-registered in the server according to a user command, receiving client information for client authentication from the server, capturing an image of a user of the terminal when the client information is received, and authenticating the user of the terminal on the basis of a facial image included in the client information and the captured image of the user of the terminal, and receiving a file uploaded by the second terminal according to the authentication result.

The receiving may include receiving access to the uploaded when the facial image included in the client information matches the image of the user of the terminal, and receiving, when the facial image included in the client information does not match the image of the user of the terminal, a file set that is shared by the second terminal.

The receiving may include receiving, when the captured image of the user of the terminal includes a plurality of facial images, a file set that is shared by the second terminal.

The method may further include receiving second client information, which further includes event information indicating that a new file has been uploaded, from the server, the capturing may include automatically re-capturing the image of the user of the terminal and re-authenticating the user on the basis of a facial image included in the second client information and the re-captured image when the second client information further including the event information is received.

A method of controlling a server, which communicates with at least one of a first terminal and a second terminal to operate according to an exemplary embodiment includes storing a file uploaded by a first user of the first terminal, allowing the second terminal to access the server, when access is requested by the second terminal with a pre-registered account of the first terminal, transmitting stored client information for client authentication to the second terminal when the second terminal accesses the server with the pre-registered account, receiving an authentication result, and transmitting the uploaded file to the second terminal according to the received authentication result.

The client information may include a facial image of the first user, and the authentication result may be a result indicating whether the facial image of the first user matches an image of a user captured by the second terminal.

The transmitting of the uploaded file to the second terminal may include transmitting the uploaded file to the second terminal when the received authentication result shows that the facial image of the first user matches the image of the user captured by the second terminal, and transmitting a file set that is shared by the first terminal among a plurality of the uploaded files to the second terminal when the received authentication result shows that the facial image of the first user does not match the image of the user captured by the second terminal.

The method may further include transmitting, when a new file is uploaded by the first terminal and stored, client information to the second terminal, the second client information including event information indicating that the new file has been uploaded.

According to an exemplary embodiment, a method of controlling a terminal, which communicates with a server to operate is provided, the method includes: accessing the server with an account of a second user, receiving, from the server, client information including a facial image of the second user to authenticate of a user of the terminal, capturing an image of the user of the terminal, authenticating the user of the terminal on the basis of the facial image of the second user included in the client information and the captured image of the user of the terminal, and receiving an uploaded file according to the authentication result.

The receiving an uploaded file may include: receiving access to the uploaded file when the facial image of the second user included in the client information matches the image of the user of the terminal; and receiving access to a file set that is shared by the second terminal when the facial image included in the client information does not match the image of the user.

As described above, various aspects of exemplary embodiments, check whether a second user accessing a server with a first user's account is the first user to determine whether to share a file uploaded by the first user, thus preventing a file for which sharing with the second user is not desired from being exposed to the second user.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the inventive concept will be more apparent by describing certain exemplary embodiments with reference to the accompanying drawings, in which:

FIG. 1 is a diagram of a general cloud service system;

FIG. 2 is a flowchart of a method of providing a file uploaded to a server in a cloud service system according to an exemplary embodiment;

FIG. 3 is a block diagram of a terminal according to an exemplary embodiment;

FIG. 4 is a block diagram illustrating a detailed configuration of a photographing unit consistent according to an exemplary embodiment;

FIG. 5 is a block diagram of a server that communicates with at least one of first and second terminal in the cloud service system according to an exemplary embodiment;

FIG. 6 is a flowchart of a method in which the second terminal communicating with the server receives a file uploaded by the first terminal in the cloud service system according to an exemplary embodiment; and

FIG. 7 is a flowchart of a method in which the server provides a file uploaded by the first terminal to the second terminal in the cloud service system according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

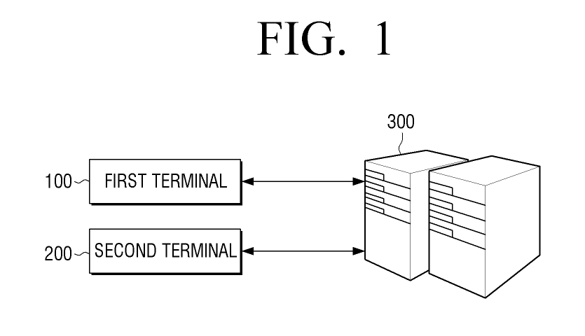

FIG. 1 is a diagram of a general cloud service system.

As illustrated in FIG. 1, the cloud service system includes a plurality of terminal 100 and 200 (hereinafter referred to as first and second terminal) and a server 300. The first and second terminal 100 and 200 may access the server 300 with a pre-registered account, and upload a file, which a user requests, to the server 300. The server 300 may store a file, uploaded by the first and second terminal 100 and 200, in a storage unit. Also, either of the first and second terminals 100 and 200 may access the server 300 with an account of the other terminal, and receive a file which is uploaded and stored by the other terminal.

For example, the first terminal 100 may access the server 300 with an account “abc@samsung.com”, and upload a music file, which a user requests, to the server 300. Therefore, the server 300 may store the music file, uploaded from the first terminal 100, in the storage unit. In this way, when all files including the music file uploaded from the first terminal 100 have been stored, the second terminal 200 may access the server 300 with the same account “abc@samsung.com” as the first terminal 100. In this case, the server 300 may determine that the second terminal 200 has accessed the server 300 with the account of the first terminal 100, and provide all files uploaded by the first terminal 100 to the second terminal 200. Accordingly, the second terminal 200 may view all files uploaded by the first terminal 100 from the server 300, and receive and output a file selected by a user among the viewed files.

As another example, when the first terminal 100 registered in the server 300 with the account “abc@samsung.com” has accessed the server 300, the second terminal 200 may access the server 300 with the account “abc@samsung.com” of the first terminal 100. That is, the first and second terminal 100 and 200 may simultaneously access the server 300 with the same account. When the first and second terminal 100 and 200 have simultaneously accessed the server 300, the first terminal 100 may upload a file for which sharing with the other user is not desired to the server 300. In this case, the server 300 checks that the second terminal 200 has accessed the server 300 with the account of the first terminal 100, and enables the second terminal 200 to share a file which is currently uploaded by the first terminal 100. Accordingly, the second terminal 200 may receive a file of the first terminal 100 for which sharing with the other user is not desired from the server 300.

As described above, in the general cloud service system, when the second terminal 200 accesses the server 300 with the account of the first terminal 100, the second terminal 200 may receive all files uploaded by the first terminal 100. That is, the second terminal 200 may receive all files that include a file for which sharing with the other user is not desired among files uploaded by the first terminal 100, thus causing the privacy of a user who has uploaded the files to be invaded.

The operation of the general cloud service system has been schematically described above. Hereinafter, a cloud service system according to an exemplary embodiment will be described schematically.

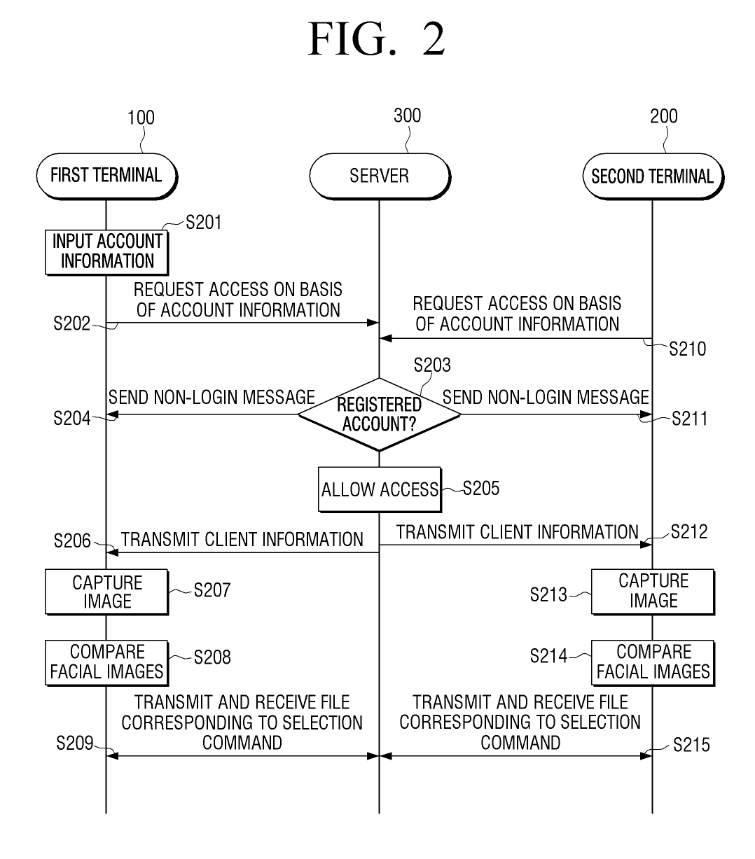

FIG. 2 is a flowchart of a method of providing a file uploaded to a server in a cloud service system according to an exemplary embodiment.

As described above with reference to FIG. 1, the cloud service system may include the first and second terminal 100 and 200 and the server 300. The first and second terminal 100 and 200 are terminal enabling the use of the cloud service, and for example, are Internet-enabled terminal such as smart phones and smart TVs. Either of the first and second terminal 100 and 200 may upload a file which a user requests, to the server 300 over the Internet, or receive a file, uploaded by the other terminal, from the server 300.

The server 300 may store an uploaded file in response to a request of at least one of the first and second terminal 100 and 200, or transmit a stored file to a corresponding terminal. In addition, the server 300 may build all applications. Therefore, at least one of the first and second terminals 100 and 200 may access the server 300 with a pre-registered account, and use applications built in the server 300. That is, the first and second terminal 100 and 200 do not include a separate application which is internally built, and may access the server 300 including built applications in TCP/IP or IPX protocol, receive an application execution image requested by a user from the server 300, and output the application execution image on a display screen.

However, the exemplary embodiments are not limited thereto, and the first and second terminal 100 and 200 may drive an operating system (OS) program or application program (stored in the server 300) as well as an application stored in the server 300 and output the driven result. According to an exemplary embodiment, an operation in which a file uploaded to the server 300 by one of the first and second terminal 100 and 200 is used by the other terminal is described.

Specifically, as illustrated, when account information pre-registered in the server 300 is input from a user, the first terminal 100 requests access from the server 300 on the basis of the input account information in operations S201 and 202. In response to the access request, the server 300 determines whether the account information received from the first terminal 100 is pre-registered, and when it is determined that the received account information is not pre-registered, the server 300 sends a non-login message to the first terminal 100 in operations S203 and S204. When it is determined that the received account information is pre-registered, the server 300 allows the access of the first terminal 100 in operation S205. At this point, the server 300 transmits client information for client authentication to the first terminal 100, for determining whether a user (hereinafter referred to as a client) of the first terminal 100 accessing the server 300 with a pre-registered account is a pre-registered user in operation S206.

The client information for client authentication is information which is first stored in the server 300 to be matched with a pre-registered account, and may include facial image information of the client. However, the exemplary embodiments are not limited thereto, and the client information may include voice information or password information of the client for client authentication.

When the client information is received from the server 300, the first terminal 100 captures an image with a built-in camera, and compares the captured facial image with a facial image included in the client information received from the server 300 to determine whether the two facial images match in operations S207 and S208. When it is determined that the two facial images match, the first terminal 100 may display a list of all files stored in the server 300 on a screen. Here, the files stored in the server 300 are files uploaded by the first terminal 100. Therefore, while the list of all files uploaded to the server 300 is being displayed on a screen, when a selection command for a specific file is input, the first terminal 100 may receive a file corresponding to the input selection command from the server 300 and output the received file in operation S209.

The second terminal 200 may request access from the server 300 with the same account as the first terminal 100 in operation S210. Here, the first terminal 100 may or may not be currently accessing the server 300. In response to an access request of the second terminal 200, the server 300 determines whether account information received from the second terminal 200 through operation S203 is the pre-registered account, and when it is determined that the received account information is not the pre-registered account, the server 300 sends a non-login message to the second terminal 200 in operation S211. When it is determined that the received account information is the pre-registered account, the server 300 allows the access of the second terminal 200 through operation S205. At this point, the server 300 transmits client information for client authentication to the second terminal 200, for determining whether a user of the second terminal 200 accessing the server 300 with the pre-registered account is a pre-registered client in operation S212.

Here, as described above, the client information may include facial image information of the client. When the client information is received from the server 300, the second terminal 200 captures an image with a built-in camera, and compares the captured facial image with a facial image, which is included in the client information received from the server 300, to determine whether the two facial images match in operations S213 and S214. When it is determined that the two facial images do not match, the second terminal 200 may display a list of files set to be shared by the client among all files stored in the server 300 on a screen.

Here, the files stored in the server 300 are files uploaded by the first terminal 100. Therefore, while the list of files set to be shared among all files uploaded to the server 300 is being displayed on a screen, when a selection command for a specific file is input, the second terminal 200 may receive a file corresponding to the input selection command from the server 300 and output the received file in operation S215.

As described above, the first and second terminal 100 and 200 may access the server 300 with the same account. That is, when the first terminal 100 has accessed the server 300 with the pre-registered account, the second terminal 200 may access the server 300 with the account of the first terminal 100. In this way, when the first and second terminal 100 and 200 have accessed the server 300 with the account of the first terminal 100, the first terminal 100 may upload a new file to the server 300 in response to a request of the client. When the new file is uploaded from the first terminal 100, the server 300 may transmit client information including event information, indicating that the new file has been uploaded, to the second terminal 200 accessing the server 300 with the account of the first terminal 100. When the client information is received, the second terminal 200 determines whether a user of the second terminal 200 is the client through operations S213 and 214. When it is determined that the user of the second terminal 200 is not the client, the second terminal 200 may display only a list of files set to be shared by the client on a screen.

When the first and second terminal 100 and 200 have accessed the server 300 with the account of the first terminal 100, even if a new file is uploaded to the server 300 by the first terminal 100, the user of the second terminal 200 cannot know that the new file has been currently uploaded by the client.

As described above, in the cloud service system according to an exemplary embodiment, when the second terminal 200 accesses the server 300 with the account of the first terminal 100, the second terminal 200 is allowed to receive only a file set to be shared among files uploaded by the first terminal 100, thus preventing a problem of another user invading the privacy of a client by viewing all files of the client.

Hereinafter, the first and second terminal 100 and 200 and the server 300 configuring the above-described cloud service system according to an exemplary embodiment will be described in detail.

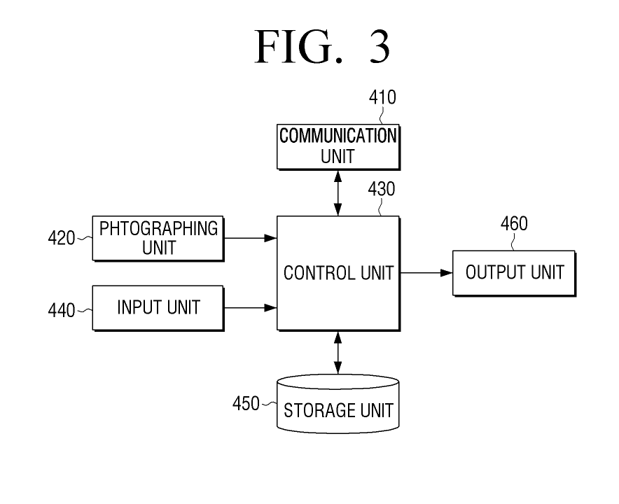

FIG. 3 is a block diagram of a terminal according to an exemplary embodiment.

Before describing FIG. 3, a terminal is a terminal that receives a file uploaded to the server 300 by other terminal, and, as described above, may be the second terminal 200, and the other terminal may be the first terminal 100 that uploads a file to the server 300. However, this explanation serves merely to classify the terminal more clearly. As another example, the first terminal 100 may be a terminal that receives a file uploaded to the server 300, and the second terminal 200 may be a terminal that uploads a file to the server 300.

As illustrated in FIG. 3, the second terminal 200 includes a communication unit 410, a photographing unit 420, and a control unit 430 (e.g., a controller, etc.). The communication unit 410 communicates with the server 300 that stores a file uploaded by the other terminal, namely, the first terminal 100. The communication unit 410 may include a wired communication port such as a network interface card (not shown), and communicate with the server 300. However, the exemplary embodiments are not limited thereto, and the communication unit 410 may include a wireless communication module (not shown). Here, the wireless communication module (not shown) is a module that is connected to an external network and performs communication according to a wireless communication protocol such as WiFi or IEEE. Furthermore, the wireless communication module may further include a mobile communication module that accesses a mobile communication network and performs communication according to various mobile communication standards such as 3rd generation (3G), 3rd Generation Partnership Project (3GPP), and Long Term Evolution (LTE).

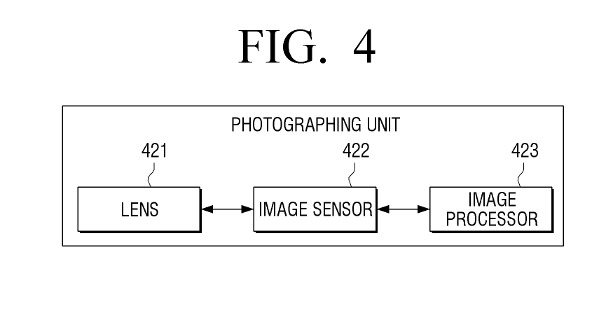

The photographing unit 420 captures an image with a camera (not shown) mounted on the second terminal 200, and may be configured as illustrated in FIG. 4. The control unit 430 may be implemented as a processor, CPU, etc. that processes computer readable instructions.

FIG. 4 is a block diagram illustrating a detailed configuration of the photographing unit consistent with an exemplary embodiment.

As illustrated in FIG. 4, the photographing unit 420 includes a lens 421, an image sensor 422, and an image processor 423. The lens 421 receives an optical signal of a subject. According to an exemplary embodiment, the lens 421 receiving the optical signal of the subject may be an inner zoom lens that protrudes internally. When the optical signal of the subject is input through the lens 421, the image sensor 422 converts the optical signal (input through the lens 421) of the subject into an electrical signal by using a capture device such as a charge coupled device (CCD) or a complementary metal oxide semiconductor (CMOS), processes the electrical signal, and outputs the signal-processed image signal to the image processor 423. Therefore, the image processor 423 performs signal processing on the image signal output from the image sensor 422, and generates the signal-processed image.

Referring again to FIG. 3, the control unit 430 accesses the server 300 with the same account as the first terminal 100 accessing the server 300, and receives client information for client authentication from the server 300 through the communication unit 410 according to a user command which is input from the user through the input unit 440. When the client information for client authentication is received from the server 300, the control unit 430 authenticates the client on the basis of a facial image included in the received client information and a facial image of a user captured by the photographing unit 420. Then, the control unit 430 controls the communication unit 410 to receive a file which is uploaded to the server 300 by the first terminal 100, on the basis of the result of client authentication.

Specifically, the control unit 430 receives account information of the first terminal 100 from the user through the input unit 440. The input unit 440 is an input means that receives various user commands and transfers the user commands to the control unit 430, and may be implemented as an input panel. The input panel may be implemented as a touch pad, a touch screen, or a key pad including various functional keys, number keys, special keys, and letter keys. When the account information of the first terminal 100 is input through the input unit 440, the control unit 430 requests access from the server 300 with the same account as the first terminal 100 through the communication unit 410. For example, the account of the first terminal 100 registered in the server 300 may be abc@samsung.com. Therefore, the control unit 430 may request access from the server 300 with the account “abc@samsung.com” of the first terminal 100.

Therefore, the server 300 may determine that the second terminal 200 has requested access with the account of the first terminal 100, and allow the access of the second terminal 200. In this way, when the access of the second terminal 200 is made with the account of the first terminal 100, the server 200 may transmit client information associated with the first terminal 100 to the second terminal 200, for checking whether a user of the second terminal 200 is a client. The client information may include facial image information of the client. However, the exemplary embodiments are not limited thereto, and the client information may include voice information or password information of the client. In an exemplary embodiment, the client information includes the facial image information of the client.

When client information is received from the server 300 through the communication unit 410, the photographing unit 420 captures an image to generate a facial image of a user according to a control command of the control unit 430. However, the exemplary embodiments are not limited thereto. In another aspect of an exemplary embodiment, according to the control command of the control unit 430, when access to the server 300 with the account of the first terminal 100 is allowed, the photographing unit 420 may capture an image to generate the facial image of the user, and the control unit 430 may store the facial image of the user generated by the photographing unit 420 in the storage unit 450.

When the facial image of the user is generated, the control unit 430 compares the facial image of the user with a facial image of the client, which is included in the client information received from the server 300, to determine whether the two facial images match. When it is determined that the two facial images match, the control unit 430 may control the communication unit to receive all files uploaded by the first terminal 100 from the server 300. When it is determined that the two facial images do not match, the control unit 430 may control the communication unit to receive only a file which is set to be shared by the client among all files uploaded by the first terminal 100.

According to aspect of an another exemplary embodiment, when an image captured by the photographing unit 420 includes a plurality of users' facial images, the control unit 430 may control the communication unit to receive a file which is set to be shared by the first terminal 100. Specifically, the photographing unit 420 capturing an image may capture a plurality of users according to the control command of the control unit 430. Therefore, when the plurality of users' facial images are generated, the control unit 430 may control the communication unit to receive a file set to be shared by the first terminal 100, irrespective of whether the generated facial images match the facial image included in the client information.

In this way, the control unit 430 that controls the communication unit 410 to receive a file uploaded by the first terminal 100 from the server 300 may control the communication unit to receive all files uploaded by the first terminal 100 or a file set to be shared of the all files. According to an exemplary embodiment, the control unit 430 may compare two facial images, and transmit authentication result information based on the compared result to the server 300. The server 300 may then transmit a list of all files uploaded by the first terminal 100 or a list of files which are set to be shared by the client among the all files to the second terminal 200, on the basis of the authentication result information. Therefore, an output unit 460 may output the list, received from the server 300, onto a screen according to a control command of the control unit 430.

According to another aspect of an exemplary embodiment, the client information for client authentication received from the server 300 may further include a list of all files uploaded by the first terminal 100 and shared file information which is set by the client. Therefore, the control unit 430 may compare two facial images, and when the two facial images match, the control unit 430 may control the output unit 460 to output a list of all files, included in the client information, on a screen. Alternatively, when the two facial images do not match or a plurality of users' facial images are generated, the control unit 430 generates a list of files set to be shared on the basis of the shared file information included in the client information, and may control the output unit 460 to output the generated list on a screen.

In this way, while the list is being displayed on the screen, when a reception request command for a specific file is input from the user through the input unit 440, the control unit 430 receives the specific file, corresponding to the request command of the user, from the server 300 through the communication unit 410. Then, the output unit 460 may output the specific file received from the server 300 through at least one of audio and video according to a control command of the control unit 430.

The above-described client information may further include event information indicating that a new file has been uploaded. When the client information including the event information is received, the control unit 430 may control the photographing unit 420 to automatically capture a facial image of a user.

Specifically, the first and second terminal 100 and 200 may access the server 300 with the same account. That is, when the first terminal 100 has accessed the server 300 with a pre-registered account, the second terminal 200 may access the server 300 with the account of the first terminal 100. In this way, when the first and second terminal 100 and 200 have accessed the server 300 with the account of the first terminal 100, the first terminal 100 may upload a new file to the server 300 in response to a request of the client. When the new file is uploaded from the first terminal 100, the server 300 may transmit client information, including event information indicating that the new file has been uploaded and a facial image, to the second terminal 200 accessing the server 300 with the account of the first terminal 100. When the client information is received, the control unit 430 controls the photographing unit 420 to automatically capture a facial image of a user. In response to such a control command, the photographing unit 420 captures the face of the user to generate a facial image corresponding to the captured face, and as described above, the control unit 430 compares the facial image of the user with the facial image included in the client information to determine whether the two facial images match.

When it is determined that the two facial images match, the control unit 430 controls the communication unit 410 to receive all files including the new file uploaded by the first terminal 100. On the other hand, when it is determined that the two facial images do not match, the control unit 430 controls the communication unit 410 to receive only a file set to be shared among all files uploaded by the first terminal 100. In this way, when the first and second terminal 100 and 200 have accessed the server 300 with the account of the first terminal 100, even if a new file is uploaded to the server 300 by the first terminal 100, the user of the second terminal 200 cannot know that the new file has been currently uploaded by the client.

The above description of the cloud service system consistent with an exemplary embodiment relates to the elements of the second terminal 200 that accesses the server 300 with the account of the first terminal 100 and uses a file uploaded to the server 300 by the first terminal 100.

Hereinafter, in the cloud service system consistent with an exemplary embodiment, the elements of the server 300 that transmits a file, uploaded by the first terminal 100, to the second terminal 200 accessing the server 300 with the account of the first terminal 100 will be described.

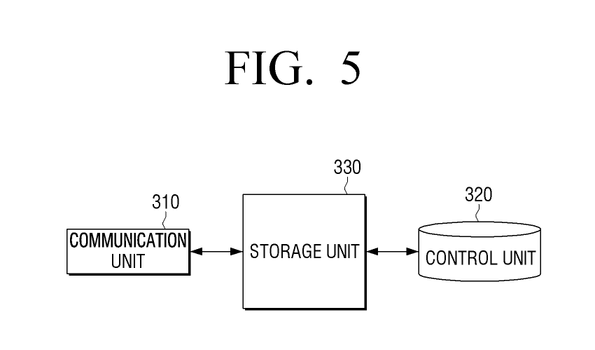

FIG. 5 is a block diagram of the server that communicates with at least one of the first and second terminal in the cloud service system according to an exemplary embodiment.

As illustrated in FIG. 5, the server 300 includes a communication unit 310, a storage unit 320, and a control unit 330 (e.g., controller, etc.). The communication unit 310 communicates with the first and second terminal 100 and 200. Here, the first and second terminal 100 and 200 are terminal capable of performing the same function. In an described exemplary embodiment, for the convenience of the description, it is assumed that the first terminal 100 is a terminal uploading a file according to a request of a client, and the second terminal 200 is a terminal which accesses the server 300 with the account of the first terminal 100 and uses a file uploaded by the first terminal 100.

The communication unit 310 communicates with the first and second terminal 100 and 200 may include a wired communication port such as a network interface card (not shown). Alternatively, the communication unit 310 may include a wireless communication module that supports a communication network such as the 3G network or the WiFi network, and communicates with the first and second terminal 100 and 200.

The storage unit 320 stores files uploaded by the first terminal 100, in which case the files may be files such as music files, video files, document files, etc. In addition, the storage unit 320 may store at least one of various applications, OS programs, and application programs for driving the server 300. The storage unit 320 may include at least one type of storage medium such as a flash memory type memory, a hard disk type memory, a multimedia card micro type memory, a card type memory (for example, SD or XD memory), a random access memory (RAM), and a read-only memory (ROM).

When the second terminal 200 accesses the server 300 with the account of the first terminal 100, the control unit 330 transmits client information for client authentication to the second terminal 200. Here, the client information for client authentication may include facial image information of a client that uploads a file with the first terminal 100, and the facial image information may be stored in the storage unit 320 together with account information of the first terminal 100.

When the second terminal 200 accesses the server 300 with the account of the first terminal 100, the control unit 330 obtains a facial image, which corresponds to corresponding account information, from the storage unit 320, and transmits client information including the obtained facial image to the second terminal 200. Subsequently, when an authentication result is received from the second terminal 200, the control unit 330 controls the communication unit 310 to transmit a file, which is uploaded by the first terminal 100 and stored in the storage unit 320, to the second terminal 200 according to the received authentication result. Here, the authentication result may be result information based on whether a facial image of a user captured by the second terminal 200 matches the facial image of the client included in the client information.

When the authentication result is received from the second terminal 200, the control unit 330 may analyze the received authentication result to transmit a file, which is uploaded by the first terminal 100 and stored in the storage unit 320, to the second terminal 200. Specifically, when the received authentication result is result information indicating that the facial image of the user captured by the second terminal 200 matches the facial image of the client included in the client information, the control unit 330 transmits all files or a list of all files, uploaded by the first terminal 100, to the second terminal 200.

When the received authentication result is result information indicating that the facial image of the user captured by the second terminal 200 does not match the facial image of the client included in the client information, the control unit 330 transmits only a file set or a list of files to be shared by the first terminal 100 among the all files uploaded by the first terminal 100 to the second terminal 200.

When a new file is uploaded by the first terminal 100 and stored in the storage unit 320, the control unit 330 may transmit client information, which further includes event information indicating that the new file has been uploaded, to the second terminal 200. Specifically, the first and second terminal 100 and 200 may access the server 300 with the same account. That is, when the first terminal 100 has accessed the server 300 with a pre-registered account, the second terminal 200 may access the server 300 with the account of the first terminal 100. In this way, when the first and second terminal 100 and 200 have accessed the server 300 with the account of the first terminal 100, the first terminal 100 may upload a new file to the server 300 in response to a request of the client. In this case, the control unit 330 may transmit client information, which includes event information indicating that the new file has been uploaded and the facial image of the client, to the second terminal 200 accessing the server 300 with the account of the first terminal 100.

Subsequently, as described above, when the authentication result is received from the second terminal 200, the control unit 330 may transmit all files (including the new file uploaded by the first terminal 100) to the second terminal 200, or transmit only a file (which is set to be shared by the first terminal 100) to the second terminal 200 according to the received authentication result.

The above description of the cloud service system according to an exemplary embodiment has discussed the elements of the server 300 that transmits a file uploaded by the first terminal 100 to the second terminal 200 accessing the server 300 with the account of the first terminal 100. Hereinafter, a method in which the second terminal 200 accessing the server 300 with the account of the first terminal 100 receives a file uploaded by the first terminal 100 from the server 300, and a method in which the server 300 transmits a file, uploaded by the first terminal 100, to the second terminal 200 will be described.

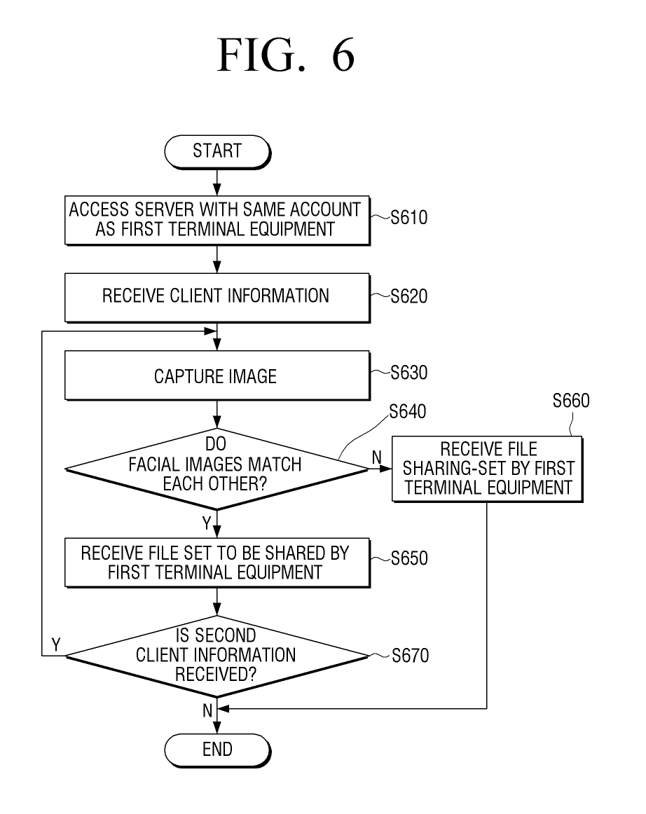

FIG. 6 is a flowchart of a method in which the second terminal communicating with the server receives a file uploaded by the first terminal in the cloud service system according to an exemplary embodiment.

As illustrated in FIG. 6, in response to a request of a user, the second terminal 200 may access the server 300 with the same account as the first terminal 100 in operation S610. For example, the account of the first terminal 100 registered in the server 300 may be abc@samsung.com. Therefore, in response to a request of a user of the second terminal 200, the second terminal 200 may request access from the server 300 with the account “abc@samsung.com” of the first terminal 100. In response to the access request, when the second terminal accesses the server 300 with the account of the first terminal 100, the second terminal 200 receives client information for authentication information from the server 300 in operation S620. Here, the client information is information for checking whether the user is a client, and may include facial image information of the client.

When the client information is received, the second terminal 200 captures a face of the user to generate a facial image of the user in operation S630. Subsequently, the second terminal 200 authenticates the client on the basis of the facial image of the user and the facial image of the client included in the client information, and receives a file uploaded by the first terminal 100 from the server 300 according to the authentication result. Specifically, the second terminal 200 compares the facial image of the user and the facial image of the client included in the client information to determine whether the two facial images match in operation S640.

When it is determined that the two facial images match, the second terminal 200 receives all files uploaded by the first terminal 100 from the server 300 in operation S650. When it is determined that the two facial images do not match, the second terminal 200 receives only a file set to be shared by the first terminal 100 among the all files uploaded by the first terminal 100 from the server 300 in operation S660.

According to another aspect of an exemplary embodiment, when the facial image captured through operation S630 includes a plurality of users' facial images, the second terminal 200 may receive only a file set to be shared by the first terminal 100 irrespective of whether the plurality of users' facial images match the facial image included in the client information. Specifically, when it is determined that the two facial images match, the second terminal 200 may output a list of all files, uploaded by the first terminal 100, onto a screen. Also, when the two facial images do not match or the captured image includes the plurality of users' facial images, the second terminal 200 may output a list of files set to be shared on a screen. In this way, while the list is being displayed on the screen, when a reception request command for a specific file is input from the user, the second terminal 200 may receive the specific file from the server 300 according to the request command of the user, and output the specific file through at least one of audio and video.

According to another aspect of an exemplary embodiment, the second terminal 200 may receive client information further including event information indicating that a new file has been uploaded from the server 300. That is, the second terminal 200 may determine whether second client information which further includes the event information indicating that the new file has been uploaded is received from the server 300 in operation S670, and when the second client information is received, the facial image of the user may be automatically captured through operation S630.

Specifically, the first and second terminal 100 and 200 may access the server 300 with the same account. That is, when the first terminal 100 has accessed the server 300 with a pre-registered account, the second terminal 200 may access the server 300 with the account of the first terminal 100. In this way, when the first and second terminal 100 and 200 have accessed the server 300 with the account of the first terminal 100, the first terminal 100 may upload a new file to the server 300 in response to a request of the client. When the new file is uploaded from the first terminal 100, the server 300 may transmit the second client information, which includes event information indicating that the new file has been uploaded and a facial image, to the second terminal 200 accessing the server 300 with the account of the first terminal 100. When the second client information is received, the second terminal 200 automatically captures a face of the user to generate a facial image corresponding to the captured face. Subsequently, the second terminal 200 compares the facial image of the user and the facial image included in the second client information to determine whether the two facial images match in operation S640. Then, the second terminal 200 may receive all files including the new file uploaded by the first terminal 100 or only a file set to be shared according to whether the two facial images match.

So far, the detailed description has been made on the method consistent with an exemplary embodiment in which the second terminal 200 accessing the server 300 with the account of the first terminal 100 receives the file uploaded by the first terminal 100 from the server 300. Hereinafter, a method in which the server 300 consistent with and exemplary embodiment transmits a file, uploaded by the first terminal 100, to the second terminal 200 will be described.

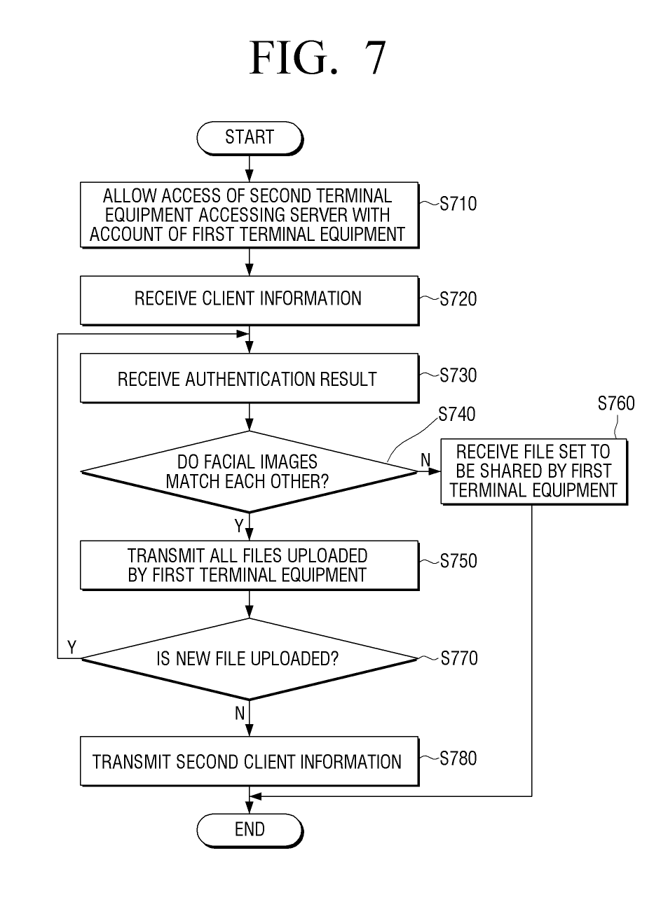

FIG. 7 is a flowchart of a method in which the server provides a file uploaded by the first terminal to the second terminal in the cloud service system according to an exemplary embodiment.

As illustrated in FIG. 7, when the second terminal 200 requests access with the account of the first terminal 100, the server 300 allows the access of the second terminal 200 accessing the server 300 with the account of the first terminal 100 in operation S710. When the second terminal 200 accesses the server 300 with the pre-registered account of the first terminal 100, the server 300 transmits stored client information for client authentication to the second terminal 200 in operation S720. Here, the client information for client authentication may include facial image information of a client that uploads a file with the first terminal 100, and the facial image information may be stored in the server 300 together with account information of the first terminal 100.

Therefore, when the second terminal 200 accesses the server 300 with the account of the first terminal 100, the server 300 obtains the facial image of the client which is stored together with account information of the first terminal 100, and transmits client information including the obtained facial image to the second terminal 200. Subsequently, the server 300 receives an authentication result from the second terminal 200 transmitting the client information in operation S730. Here, the authentication result may be result information based on whether a facial image of a user captured by the second terminal 200 matches the facial image of the client included in the client information. Thus, when the authentication result is received, the server 300 may transmit the file uploaded by the first terminal 100 to the second terminal 200 on the basis of the received authentication result.

Specifically, when the authentication result is received from the second terminal 200, the server 300 may analyze the received authentication result to determine whether the facial image of the user captured by the second terminal 200 matches the facial image of the client in operation S740. When the received authentication result shows that the two facial images match, the server 300 transmits all files uploaded by the first terminal 100 to the second terminal 200 in operation S750. When the received authentication result shows that the two facial images do not match, the server 300 transmits only a file set to be shared by the first terminal 100 among the all files uploaded by the first terminal 100 to the second terminal 200 in operation S760.

In this way, the server 300 according to an exemplary embodiment may determine whether to share the files uploaded by the first terminal 100, with the other user according to the authentication result indicating whether the facial image of the user of the second terminal 200 accessing the server 300 with the account of the first terminal 100 matches the facial image of the client.

According to another aspect of an exemplary embodiment, when a new file is uploaded by the first terminal 100 and stored in the server 300, the server 300 may transmit client information, which further includes event information indicating that the new file has been uploaded, to the second terminal 200.

Specifically, the first and second terminal 100 and 200 may access the server 300 with the same account. That is, when the first terminal 100 has accessed the server 300 with a pre-registered account, the second terminal 200 may access the server 300 with the account of the first terminal 100. In this way, when the first and second terminal 100 and 200 have accessed the server 300 with the account of the first terminal 100, the first terminal 100 may upload a new file to the server 300 in response to a request of the client. Therefore, the server 300 determines whether the new file is uploaded by the first terminal 100 in operation S770. When it is determined that the new file is uploaded by the first terminal 100, the server 300 generates second client information that includes event information indicating that the new file has been uploaded and the facial image of the client, and transmits the second client information to the second terminal 200 in operation S780.

Subsequently, as described above, when the authentication result is received from the second terminal 200, the server 300 may transmit all files (including the new file uploaded by the first terminal 100) to the second terminal 200, or transmit only a file (which is set to be shared by the first terminal 100) to the second terminal 200 according to the received authentication result.

The foregoing exemplary embodiments and advantages are merely exemplary and are not to be construed as limiting the inventive concept. The exemplary embodiments may be readily applied to other types of apparatuses. Also, the description of the exemplary embodiments is intended to be illustrative, and not to limit the scope of the claims, and many alternatives, modifications, and variations that will be apparent to those skilled in the art.

What is claimed is:

1. A terminal comprising:
a communication unit which communicates with a server storing a file uploaded by a second terminal;
a photographing unit which captures an image of a user of the terminal; and
a controller which controls the communication unit to receive client information for client authentication from the server when the terminal accesses the server with a same account as the second terminal, authenticates the user of the terminal on the basis of a facial image included in the client information and the image of the user captured by the photographing unit, and receives the uploaded file according to the authentication result.

2. The terminal as claimed in claim 1, wherein,
when the facial image included in the client information matches the image of the user captured by the photographing unit, the controller receives access to the uploaded file, and
when the facial image included in the client information does not match the image of the user captured by the photographing unit, the controller controls the communication unit to receive access to a file set that is shared by the second terminal.

3. The terminal as claimed in claim 1, wherein, when the image captured by the photographing unit includes a plurality of user facial images, the controller controls the communication unit to receive access to a file set that is shared by the second terminal.

4. The terminal as claimed in claim 1, wherein, when second client information that further includes event information indicating that a new file has been uploaded, is received from the server, the controller controls the photographing unit to automatically re-capture the image of the user and re-authenticates the user on the basis of a facial image included in the second client information and the image re-captured by the photographing unit.

5. A server comprising:
a communication unit which communicates with a first terminal and a second terminal;
a storage unit which stores a file uploaded by a first user of the first terminal; and
a controller which controls the communication unit to transmit client information for client authentication to the second terminal when the second terminal accesses the server with a pre-registered account of the first terminal, and when an authentication result is received, controls the communication unit to transmit the uploaded file to the second terminal according to the received authentication result.

6. The server as claimed in claim 5, wherein,
the client information includes a facial image of the first user, and
the authentication result is a result indicating whether the facial image of the first user matches an image of a user captured by the second terminal.

7. The server as claimed in claim 6, wherein,
when the received authentication result shows that the facial image of the first user matches the image of the user captured by the second terminal, the controller transmits the uploaded file to the second terminal equipment, and
when the received authentication result shows that the facial image of the first user does not match the image of the second user, the controller transmits a file set that is shared by the first terminal to the second terminal.

8. The server as claimed in claim 6, wherein, when a new file is uploaded by the first terminal and stored in the storage unit, the controller controls the communication unit to transmit second client information, which includes event information indicating that the new file has been uploaded, to the second terminal.

9. A method of controlling a terminal, which communicates with a server to operate, the method comprising:
accessing the server with an account of a second terminal pre-registered in the server;
receiving client information for client authentication from the server;
capturing an image of a user of the terminal; and
authenticating the user of the terminal on the basis of a facial image included in the client information and the captured image of the user of the terminal; and
receiving a file uploaded by the second terminal according to the authentication result.

10. The method as claimed in claim 9, wherein the receiving comprises:
receiving access to the uploaded file when the facial image included in the client information matches the image of the user of the terminal; and
receiving access to a file set that is shared by the second terminal when the facial image included in the client information does not match the image of the user of the terminal.

11. The method as claimed in claim 9, wherein the receiving comprises when the captured image of the user of the terminal includes a plurality of user facial images, receiving access to a file set that is shared by the second terminal.

12. The method as claimed in claim 9, further comprising receiving second client information, which further includes event information indicating that a new file has been uploaded, from the server,
wherein the capturing comprises automatically re-capturing the image of the user of the terminal and re-authenticating the user on the basis of a facial image included in the second client information and the re-captured image when the second client information is received.

13. A method of controlling a server, which communicates with at least one of a first terminal and a second terminal to operate, the method comprising:
storing a file uploaded by a first user of the first terminal;
allowing the second terminal to access the server when access is requested by the second terminal with a pre-registered account of the first terminal;
transmitting stored client information for client authentication to the second terminal when the second terminal accesses the server with the pre-registered account;
receiving an authentication result; and
transmitting the uploaded file to the second terminal according to the received authentication result.

14. The method as claimed in claim 13, wherein,
the client information includes a facial image of the first user, and
the authentication result is a result indicating whether the facial image of the first user matches an image of a user captured by the second terminal.

15. The method as claimed in claim 14, wherein the transmitting of the uploaded file to the second terminal comprises:
transmitting the uploaded file to the second terminal when the received authentication result shows that the facial image of the first user matches the image of the user captured by the second terminal; and
transmitting a file set that is shared by the first terminal to the second terminal when the received authentication result shows that the facial image of the first user does not match the image of the user captured by the second terminal.

16. The method as claimed in claim 14, further comprising transmitting, when a new file is uploaded by the first terminal and stored, second client information to the second terminal, the client information including event information indicating that the new file has been uploaded.

17. A method of controlling a terminal, which communicates with a server to operate, the method comprising:
accessing the server with an account of a second user;
receiving, from the server, client information including a facial image of the second user to authenticate of a user of the terminal;
capturing an image of the user of the terminal; and
authenticating the user of the terminal on the basis of the facial image of the second user included in the client information and the captured image of the user of the terminal; and
receiving an uploaded file according to the authentication result.

18. The method as claimed in claim 17, wherein the receiving an uploaded file comprises:
receiving access to the uploaded file when the facial image of the second user included in the client information matches the image of the user of the terminal; and
receiving access to a file set that is shared by the second terminal when the facial image included in the client information does not match the image of the user.
